(19) United States
(12) Patent Application Publication
(10) Pub. No.: US 2018/0159931 A1
(43) Pub. Date: Jun. 7, 2018

(54) SERVER FOR PROVIDING CLOUD SERVICE AND OPERATING METHOD THEREOF

(71) Applicant: S-Printing Solution Co., Ltd., Suwon-si (KR)

(72) Inventor: Jung-hun KIM, Suwon-si (KR)

(21) Appl. No.: 15/711,579

(22) Filed: Sep. 21, 2017

(30) Foreign Application Priority Data
Dec. 5, 2016 (KR) 10-2016-0164392

(51) Int. Cl. H04L 29/08; G06F 21/31

(52) U.S. Cl. CPC H04L 67/1097; H04N 1/32432; G06F 21/31

(57) ABSTRACT

An operating method of a server for providing a cloud service is provided. The operating method includes receiving shared file information from each of a plurality of devices connected to the server, transmitting the shared file information in response to a request from one of the plurality of devices, and, when receiving a request for a shared file included in the shared file information, receiving the shared file from a device in which the shared file is stored and transmitting the shared file to a device that requested the shared file.

### CROSS-REFERENCE TO RELATED APPLICATION(S)

This application claims the benefit under 35 U.S.C. § 119(a) of a Korean patent application filed on Dec. 5, 2016 in the Korean Intellectual Property Office and assigned Serial No. 10-2016-0164392, the entire disclosure of which is hereby incorporated by reference.

### TECHNICAL FIELD

The present disclosure relates to a cloud service server and an operating method thereof.

### BACKGROUND

Recently, with the development of electronic communications technologies and network technologies, various services utilizing these technologies have been developed and released on the market. In particular, cloud services for storing software, data, etc. on high performance computers connected to a network so that the software, data, etc. can be accessed and used whenever needed have been actively developed and used.

In general, in a cloud service, a user stores necessary files on a cloud server, and when the files are needed, the user accesses and downloads the files. However, in this process, transmission of files occurs frequently, which causes consumption of network resources and data traffic. Also, as the user's files are stored on the cloud server, rather than a personal device, security issues may occur. In addition, as the amount of stored data increases, expenses regarding a storage space on the cloud server may also increase.

Therefore, a technology to reduce the burden with respect to a network and storage space and to provide enhanced security is required.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a server for providing an efficient and safe cloud service and an operating method thereof.

In accordance with an aspect of the present disclosure, an operating method of a server for providing a cloud service is provided. The operating method includes receiving shared file information from each of a plurality of devices connected to the server, transmitting the shared file information in response to a request from one of the plurality of devices, and, when receiving a request for a shared file included in the shared file information, receiving the shared file from a device in which the shared file is stored and transmitting the shared file to a device that requested the shared file.

In accordance with another aspect of the present disclosure, a server for providing a cloud service is provided. The server includes a communicator configured to communicate with each of a plurality of devices connected to the server, a memory configured to store a program for providing the cloud service, and a processor configured to execute the program so as to receive shared file information from each of the plurality of devices connected to the server, transmit the shared file information in response to a request from one of the plurality of devices, and when receiving a request for a shared file included in the shared file information, receive the shared file from a device in which the shared file is stored and transmit the shared file to a device that requested the shared file.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 shows a system for providing a cloud service according to an embodiment of the present disclosure;

FIG. 2 shows an example of a service provided by a server in the system of FIG. 1 according to an embodiment of the present disclosure;

FIG. 3 shows a method of providing a cloud service according to an embodiment of the present disclosure;

FIG. 4 shows shared file information stored in a server according to an embodiment of the present disclosure;

FIG. 5 is a flowchart of an operating method of a server for providing a cloud service according to an embodiment of the present disclosure;

FIG. 6 shows a user authentication process according to an embodiment of the present disclosure;

FIG. 7 shows a printing method using a cloud service according to an embodiment of the present disclosure; and

FIG. 8 is a block diagram of components of a server according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and word used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the present application, when a part “includes” an element, it is to be understood that the part additionally may include other elements rather than excluding other elements as long as there is no particular opposing recitation. Also, the terms such as “ . . . unit,” “module,” or the like used in the present application indicate a unit, which processes at least one function or motion, and the unit may be implemented by hardware or software, or by a combination of hardware and software.

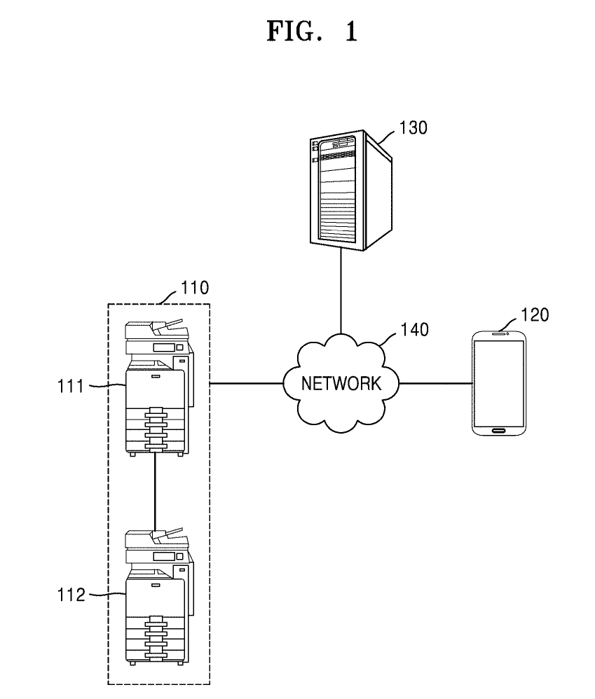

FIG. 1 shows a system for providing a cloud service according to an embodiment of the present disclosure.

Referring to FIG. 1, the system for providing the cloud service according to the present embodiment may include devices 111 and 112 included in an internal network 110, a personal device 120, and a server 130, wherein the devices 111 and 112 included in the internal network 110, the personal device 120, and the server 130 are connected to one another in an external network 140.

The devices 111 and 112 included in the internal network 110 and the personal device 120 may include various devices which may be connected to a network. For example, the devices 111 and 112 included in the network 110 and the personal device 120 may include user devices, such as personal computers (PCs), notebook computers, tablet PCs, and smart phones, image-forming devices outputting printing data, such as facsimiles, printers, scanners, and complexers, and devices, such as servers providing a service to a user.

The devices 111 and 112 included in the internal network 110 may directly communicate with each other. For example, the devices 111 and 112 included in the internal network 110 may communicate with each other via near-field communication, such as Wi-Fi, Bluetooth, etc. Also, a firewall may be provided between the internal network 110 and the external network 140.

According to an embodiment, the devices 111 and 112 included in the internal network 110 may be configured such that only one of the devices 111 and 112 included in the internal network 110 may access the external network 140 and the other one of the devices 111 and 112 may access only the internal network 110. For example, the device 112 may access only the internal network 110 and may also access the external network 140 via the device 111 which may access the external network 140. For example, the device 112, which may access only the internal network 110, may transmit and receive data to and from the server 130 via the device 111 which may access the external network 140, thereby using a cloud service. In more detail, the image-forming device 112, which may access only the internal network 110, may receive or transmit printing data from or to the external network 140 via the image-forming device 110 which may access the external network 140.

According to an embodiment, security of the cloud service may be enhanced by restricting devices which may access the external network 140.

The personal device 120 may access the external network 140 via wires or wirelessly. The personal device 120 may use the cloud service by transmitting and receiving data to and from the server 130 via the external network 140.

The server 130 may be connected to the internal network 110 and the personal device 120 via the external network 140. The server 130 may provide the cloud service.

The external network 140 may connect the internal network 110, the personal device 120, and the server 130. According to an embodiment, the external network 140 may include the internet.

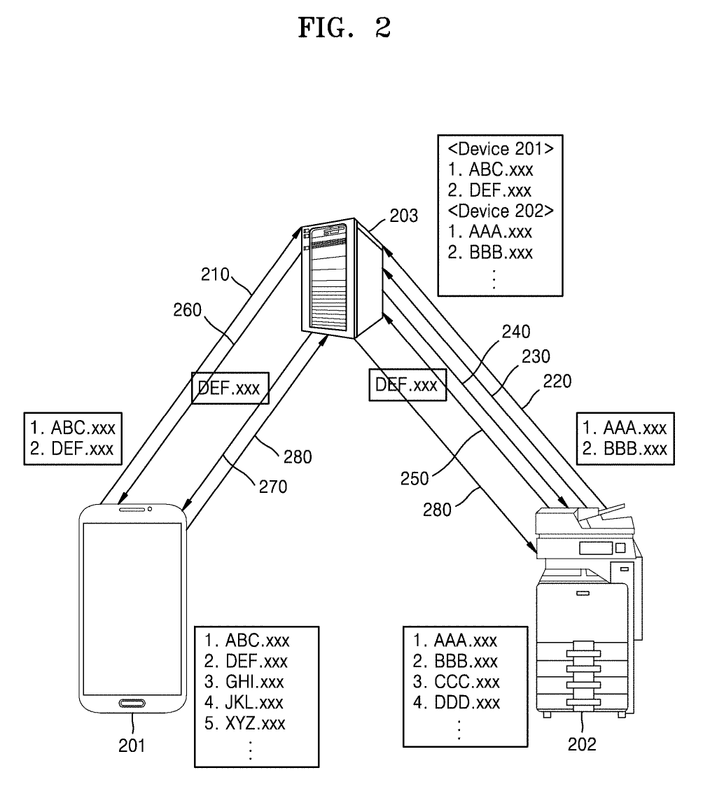

FIG. 2 shows an example of a service provided by a server in the system of FIG. 1 according to an embodiment of the present disclosure.

Referring to FIG. 2, a device 201 may transmit, to a server 203, shared file information with respect to files to be shared from among files stored in the device 201 in operation 210. The device 201 may store files such as ABC.xxx, DEF.xxx, GHI.xxx, JKL.xxx, XYZ.xxx, etc., and may share the files ABC.xxx and DEF.xxx from among the stored files. Accordingly, the device 201 may include the files ABC.xxx and DEF.xxx in a list of shared files and transmit the list to the server 203.

In operation 220, a device 202 may transmit, to the server 203, shared file information with respect to files to be shared from among files stored in the device 202. The device 202 may store files such as AAA.xxx, BBB.xxx, CCC.xxx, DDD.xxx, etc., and may share the files AAA.xxx and BBB.xxx from among the stored files. Accordingly, the device 202 may include the files AAA.xxx and BBB.xxx in a list of shared files and transmit the list to the server 203.

Operations 210 and 220 may be sequentially or simultaneously performed according to operations of the devices 201 and 202.

The server 203 may receive the shared file information from the devices 201 and 202 in operations 210 and 220, respectively, and store the shared file information. FIG. 2 illustrates that the shared file information is received from two devices. However, this is only an example, and the server 203 may receive the shared file information from additional devices and store the received shared file information. According to an embodiment, the server 203 may not store shared files themselves. However, the server 203 may store information with respect to which device is to share which files, based on the received shared file information. For example, in FIG. 2, the server 203 stores the files ABC.xxx and DEF.xxx stored in the device 201 and the files AAA.xxx and BBB.xxx stored in the device 202, as the shared file information.

In operation 230, the device 202 may request the shared file information from the server 203. The device 202 may request the shared file information from the server 203 to identify which files the other device 201 is to share. In operation 240, the server 203 receiving the request for the shared file information may transmit the shared file information that is stored in the server 203 to the device 202.

In operation 250, the device 202 may request, from the server 203, a file that is needed by the device 202 from among shared files included in the shared file information. In FIG. 2, the device 202 requests, from the server 203, the file DEF.xxx in the shared file information received from the server 203. The server 203 may request the file DEF.xxx from the device 201 in which the file DEF.xxx is stored in operation 270, and may receive the file DEF.xxx from the device 201 in operation 280. The server 203 may transmit the received file DEF.xxx to the device 202. Here, the server 203 may not store the file DEF.xxx or may temporarily store the file DEF.xxx.

According to an embodiment, the server 203 may store only information with respect to files that are to be shared by the devices 201 and 202, rather than the files themselves. That is, the server 203 may store only a list of the shared files. In response to a request for the shared file information from the device 202 which is to use a cloud service, the server 203 may transmit the shared file information to the device 202. When the device 202 requests one of shared files included in the shared file information, the server 203 may receive the file from the device 201 in which the file is stored, and transmit the file to the device 202. Thus, the server 203 and the devices 201 and 202 may transmit the file only when it is necessary, so that data traffic is reduced and the security is enhanced, because files of a user are stored in a personal device, rather than the server 203.

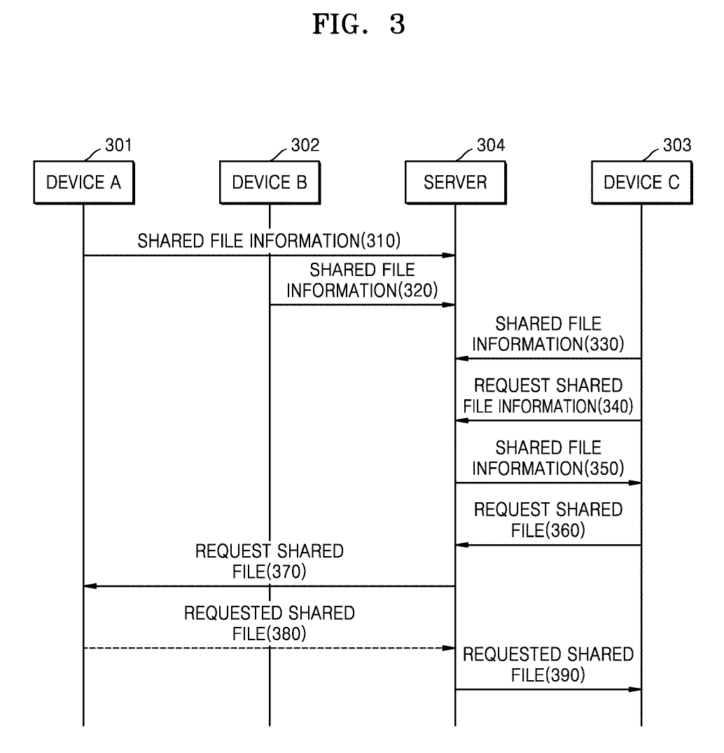

FIG. 3 shows a method of providing a cloud service according to an embodiment of the present disclosure.

Referring to FIG. 3, three devices, that is, a device A 301, a device B 302, and a device C 303, and a server 304 participate in a cloud service. As described above, the devices A, B, and C, 301, 302, and 303 may include user devices, such as PCs, notebook computers, tablet PCs, and smart phones, image-forming devices outputting printing data, such as facsimiles, printers, scanners, and complexers, and devices, such as servers providing a service to a user.

In operations 310, 320, and 330, respectively, the devices A, B, and C 301, 302, and 303 may transmit, to the server 304, shared file information, which is information with respect to files to be shared by the devices A, B, and C 301, 302, and 303. As described above, operations 310, 320, and 330 may be sequentially or simultaneously performed according to operations of the devices A, B, and C 301, 302, and 303. According to an embodiment, the devices A, B, and C 301, 302, and 303 may transmit the shared file information to the server 304, when the devices A, B, and C 301, 302, and 303 start a cloud service. Accordingly, operations 310, 320, and 330 may be sequentially or simultaneously performed based on an order in which the devices A, B, and C 301, 302, and 303 start the cloud service. The shared file information may include information with respect to files that the devices A, B, and C 301, 302, and 303 are to share from among files stored in the devices A, B, and C 301, 302, and 303. According to an embodiment, the shared file information may include a list of the files to be shared, a storage route of the files in the devices A, B, and C 301, 302, and 303, a size of the files, a sharing expiration period of the files, etc.

A plurality of users may respectively access the devices A, B, and C 301, 302, and 303. Thus, the shared file information may include user information. In more detail, when a predetermined user uses the devices A, B, and C 301, 302, and 303 and shares a file stored in the devices A, B, and C 301, 302, and 303, the shared file information may include information of the user. The user information will be described later.

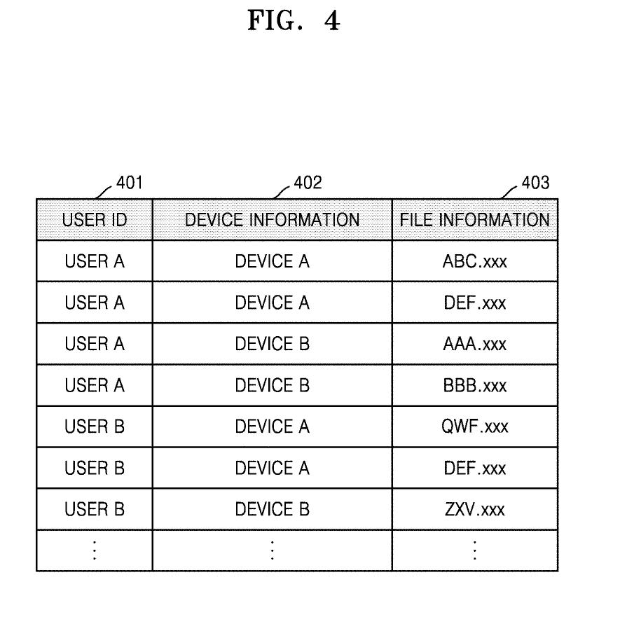

The server 304 receiving the shared file information in operations 310, 320, and 330 may store information with respect to which device is to share which files, based on the received shared file information. This aspect will be described with reference to FIG. 4.

FIG. 4 shows shared file information stored in a server according to an embodiment of the present disclosure.

Referring to FIG. 4, the shared file information may include a user identifier (ID) 401, device information 402, and file information 403. In FIG. 4, user A and user B may each use two devices, that is, the device A 301 and the device B 302.

User A may select files ABC.xxx and DEF.xxx as shared files while using a cloud service by using the device A 301, and may select files AAA.xxx and BBB.xxx as shared files while using a cloud service by using the device B 302. The device A 301 may transmit the shared file information including the files ABC.xxx and DEF.xxx selected by user A to the server 304. Also, the device B 302 may transmit the shared file information including the files AAA.xxx and BBB.xxx selected by user A to the server 304.

User B may select a files QWE.xxx and DEF.xxx as shared files while using a cloud service by using the device A 301, and may select file ZXV.xxx as a shared file while using a cloud service by using the device B 302. The device A 301 may transmit the shared file information including the files QWE.xxx and DEF.xxx selected by user B to the server 304. Also, the device B 302 may transmit the shared file information including the file ZXV.xxx selected by user B to the server 304. The server 304 may receive and store the shared file information.

According to an embodiment, different users may share an identical file by using one device. For example, in FIG. 4, both user A and user B may select the file DEF.xxx as the shared file by using the device A 301. In this case, according to the related art, the server 304 has to store the file DEF.xxx for both of the users, so that twice the storage space is needed. However, according to an embodiment, the server 304 may not store the shared file itself and may store only the shared file information, and thus, the storage space may be efficiently used.

Referring to FIG. 3 again, in operation 340, the device C 303 may request the shared file information from the server 304. A user of the device C 303 may request the shared file information from the server 304 in order to use a cloud service.

In operation 350, the server 304 receiving the request for the shared file information may transmit the shared file information to the device C 303. According to an embodiment, the server 304 may transmit the shared file information with respect to the devices A 301 and B 302, while not transmitting the shared file information with respect to the device C 303 that requested the shared file information. Since the shared file information of the device C 303 is already known by the device C 303, transmission thereof to the device C 303 is not necessary.

In operation 360, the device C 303 may request a shared file included in the shared file information from the server 304. In FIG. 3, the device C 303 may request the shared file stored in the device A 301. The server 304 receiving the request may request the shared file from the device A 301 in which the shared file is stored, in operation 370.

In operation 380, the device A 301 may transmit the shared file requested from the server 304 to the server 304. According to an embodiment, the device A 301 may transmit the shared file to the server 304 according to a streaming method. In operation 390, the server 304 may transmit the shared file received from the device A 301 to the device C 303 that requested the shared file. According to an embodiment, the server 304 may forward the shared file to the device C 303 according to a streaming method. Via this process, the server 304 may not store the shared file or may temporarily store the shared file, when forwarding the shared file. Thus, according to an embodiment, since files of a user may be stored in a personal device, rather than the server 304, when the user uses the cloud service, the security may be enhanced.

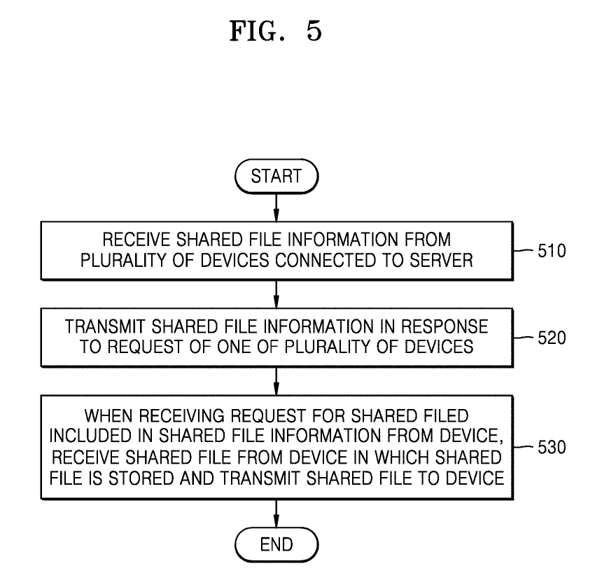

FIG. 5 is a flowchart of an operating method of a server for providing a cloud service according to an embodiment of the present disclosure.

Referring to FIG. 5, the server 304 may receive shared file information from the plurality of devices A, B, and C 301, 302, and 303 connected to the server 304 in operation 510. In more detail, the devices A, B, and C 301, 302, and 303 may be connected to the server 304 when the cloud service is started. The server 304 may receive the shared file information from each of the devices A, B, and C 301, 302, and 303. Thus, the server 304 may sequentially or simultaneously receive the shared file information from the devices A, B, and C 301, 302, and 303 based on an order in which the server 304 is connected to the devices A, B, and C 301, 302, and 303. The server 304 may store the received shared file information.

The shared file information may include information with respect to files that the devices A, B, and C 301, 302, and 303 are to share from among files stored in the devices A, B, and C 301, 302, and 303. According to an embodiment, the shared file information may include a list of the files to be shared, a storage route of the files in the devices A, B, and C 301, 302, and 303, a size of the files, a sharing expiration period of the files, etc. Also, the shared file information may include user information for identifying a user. To this end, the server 304 may perform a user authentication process for identifying the user.

According to an embodiment, the server 304 may store only the shared file information, rather than the shared file itself, and thus, a storage space may be efficiently used.

In operation 520, the server 304 may transmit the shared file information in response to a request of one device C 303 from among the plurality of devices A, B, and C 301, 302, and 303. In more detail, the server 304 may receive the shared file information requested by a user using the device C 303 to use a cloud service. Here, the request for the shared file information may include user information of the user using the device C 303. The server 304 may transmit the shared file information stored in the server 304 to the device C 303 in response to the request for the shared file information. Here, the server 304 may transmit only the shared file information with respect to the devices A and B 301 and 302, while not transmitting the shared file information with respect to device C 303 that requested the shared file information. The shared file information of the device C 303 that requested the shared file information is already known by the device C 303, and thus, transmission thereof to the device C 303 is not necessary. Also, only the shared file information with respect to the user using the device C 303 may be transmitted.

In operation 530, when the server 304 receives from the device C 303 a request for a shared file included in the shared file information, the server 304 may receive the shared file from the device A 301 in which the shared file is stored and transmit the shared file to the device C 303. In more detail, when the server 304 receives the request for the shared file from the device C 303, the server 304 may request the device A 301 in which the shared file is stored to transmit the shared file. In this case, the server 304 may determine in which device the shared file is stored, based on the shared file information stored in the server 304 or based on the request for the shared file received from the device C 303. Also, the server 304 may receive the shared file from the device A 301 in which the shared file is stored, according to a streaming method. Further, the server 304 may forward the shared file to the device C 303 that requested the shared file, according to the streaming method. Via this process, the server 304 may not store the shared file or may temporarily store the share file when the server 304 forwards the shared file to the device C 303. Thus, according to an embodiment, when a user uses a cloud service, files of the user may not be stored in the server 304 and may be stored in a personal device, and thus, the security of the cloud service may be enhanced.

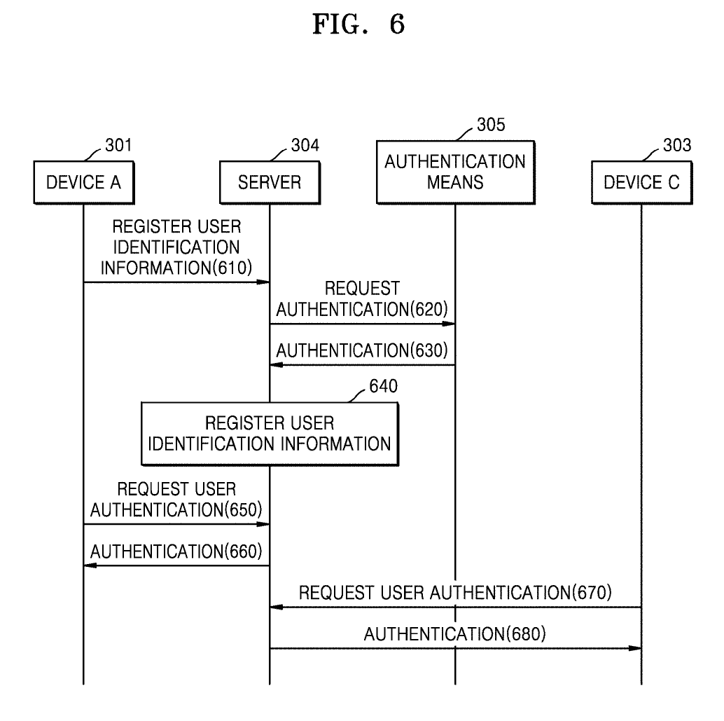

FIG. 6 shows a user authentication process according to an embodiment of the present disclosure.

Referring to FIG. 6, a user may register user identification information by using the device A 301 and may request user authentication from the server 304, by using the device A 301 and the device C 303.

In operation 610, the device A 301 may receive an input of user information from the user and request the server 304 to register user identification information. For example, the device A 301 may receive a user ID and a password from the user and may request the server 304 to register the user ID and the password. Here, the user ID may include identification information via which the user may be identified, such as an email address, a telephone number, etc.

In operation 620, the server 304 may request an authentication means 305 to authenticate the user information, and may receive authentication information in operation 630. Here, the server 304 may request the authentication means 305 to authenticate the user information based on the user identification information. For example, when the user identification information included in the user ID is an email address, the server 304 may transmit an email including an authentication universal resource location (URL), etc., to the corresponding email address, and when a user accesses the URL, the user may receive the authentication information. Also, when the user identification information included in the user ID is a telephone number, the server 304 may transmit an authentication number to the telephone number, and the user may transmit the authentication number to the server 304 so that the server 304 receives the authentication information. Further, the server 304 may use biometric information, such as iris recognition, fingerprint recognition, etc., as an authentication means.

In operation 640, the server 304 may register the authenticated user identification information.

In operation 650, the server 304 may receive a user authentication request from the device A 301 that requested the registration of the user identification information, and when the received information corresponds to the registered user identification information, the server 304 may proceed to operation 660 and perform authentication. Also, the server 304 may receive a user authentication request from the additional device C 303 in operation 670, and when the received information corresponds to the registered user identification information, the server 304 may proceed to operation 680 and perform authentication. Here, operations 650 and 670 may be simultaneously or sequentially performed.

Via this authentication process, the user may use the cloud service by using the plurality of devices A 301 and C 303.

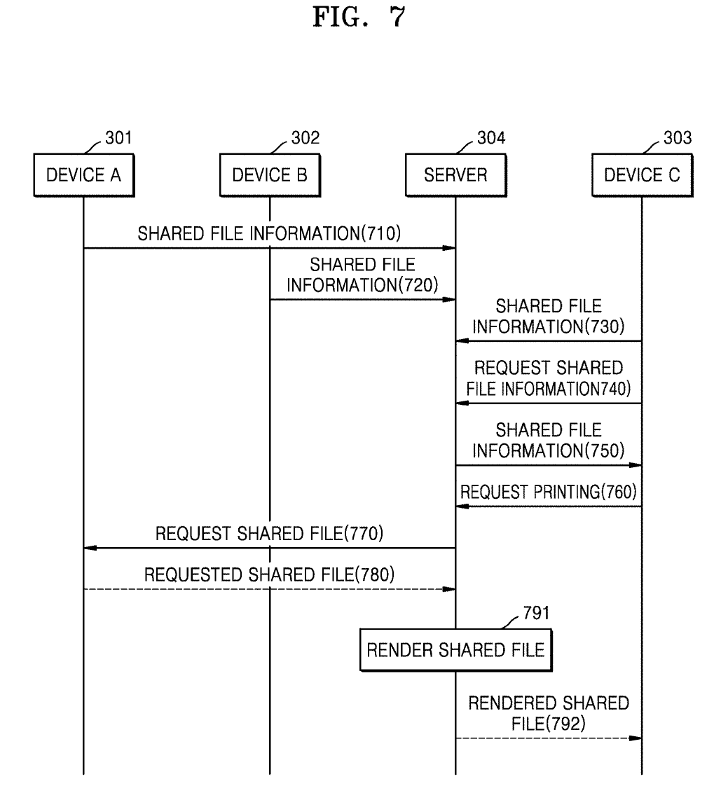

FIG. 7 shows a printing method using a cloud service according to an embodiment of the present disclosure.

Referring to FIG. 7, operations 710 through 750 are the same as operations 310 through 350 described in FIG. 3. Thus, descriptions will not be repeated, and operations performed after operation 750 will be described. Also, in FIG. 7, the device C 303 may be an image-forming device.

In operation 760, the device C 303 may request the server 304 to print the shared file included in the shared file information. In more detail, in FIG. 7, the device C 303 may request the server 304 to print the shared file stored in the device A 301. The server 304 receiving the request may request the shared file from the device A 301 in which the shared file is stored in operation 770, and may receive the shared file from the device A 301 in operation 780. According to an embodiment, the server 304 may receive the shared file from the device A 301 according to a streaming method.

In operation 791, the server 304 may perform rendering on the received shared file. Here, the rendering may be performed by the server 304 itself, or may be performed by an additional rendering server. In operation 792, the server 304 may transmit the rendered files to the device C 303. According to an embodiment, the server 304 may transmit the rendered files to the device C 303 according to the streaming method.

Via this process, a pull-printing service using a cloud service may be provided.

The operating method of the server 304 according to an embodiment is described above. Hereinafter, components of a server will be described in more detail. Aspects that are already described above will be briefly described.

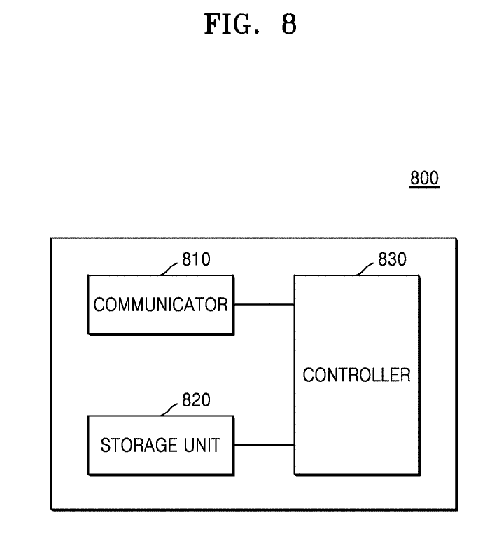

FIG. 8 is a block diagram of components of a server according to an embodiment of the present disclosure.

Referring to FIG. 8, the server 800 may include a communicator 810 (e.g., a transceiver), a memory 820 (e.g., a storage unit), and a processor 830 (e.g., a controller).

The communicator 810 may perform wired or wireless communication with another device or a network. To this end, the communicator 810 may include a communication module for supporting at least one of various wired and wireless communication methods. For example, the communication module may have the form of a chipset.

The communicator 810 may be connected to an external device located outside the server 800 and may transmit and receive signals or data to and from the external device. The server 800 may be connected to the external device via the communicator 810 and may transmit the signals or data received from the external device to the processor 830, or may transmit the signals or data generated from the processor 830 to the external device. For example, the communicator 810 may receive a shared file from a device in which the shared file is stored and the processor 830 may render the received shared file.

Various types of programs, such as applications, and various types of data, such as files, may be installed and stored in the memory 820. The processor 830 may access and use the data stored in the memory 820, or may store new data to the memory 820. Also, the processor 830 may execute the programs installed in the memory 820.

According to an embodiment, a program for providing a cloud service may be stored in the memory 820.

The processor 830 may control general operations of the server 800. In particular, the processor 830 may control a process in which the electronic server 800 provides the cloud service. Also, the processor 830 may store a signal or data input from the outside of the server 800 or may operate by using random-access memory (RAM) used as a storage area corresponding to various operations executed by the server 800 or read-only memory (ROM) in which a control program for controlling peripheral devices is stored. The processor 830 may be implemented as a system on chip (SoC) in which a core processor and a graphics processing unit (GPU) are integrated. Also, the processor may include a plurality of processors.

According to an embodiment, the processor 830 may receive shared file information from a plurality of devices connected to the server 800 and may transmit the shared file information in response to a request of one of the plurality of devices. When the processor 830 receives a request for a shared file included in the shared file information, the processor 830 may receive the shared file from a device in which the shared file is stored, and transmit the shared file to the device that requested the shared file. The shared file information may include a list of files shared by the plurality of devices. When the processor 830 receives a request for printing the shared file included in the shared file information, the processor 830 may receive the shared file from the device in which the shared file is stored, render the shared file, and transmit the rendered file to the device that requested the printing of the shared file.

According to an embodiment, the processor 830 may receive the shared file from the device in which the shared file is stored according to a streaming method, and may forward the shared file to the device that requested the shared file, according to the streaming method. Also, the processor 830 may transmit the shared file information with respect to other devices from among the plurality of devices except for the device that requested the shared file information.

According to an embodiment, the processor 830 may perform user authentication, and transmit the shared file information of an authenticated user.

The devices according to the various embodiments may include a processor, a memory for storing program data and executing it, a permanent storage such as a disk drive, a communication port for handling communications with external devices, a user interface device such as a touch panel, a key, a button, etc., etc. Any methods implemented as software modules or algorithms may be stored on a computer-readable recording medium as codes or program instructions that are readable by a computer executable on the processor. The computer-readable recording medium may include a magnetic storage medium (for example, ROM, RAM, floppy disks, hard disks, etc.), optical reading medium (for example, compact disc-ROM (CD-ROM), digital versatile disc (DVD)), etc. The computer-readable recording medium can also be distributed over network coupled computer systems so that the computer readable code is stored and executed in a distributed fashion. This media can be read by the computer, stored in the memory, and executed by the processor.

The present embodiments may be described in terms of functional block components and various processing steps. Such functional blocks may be realized by any number of hardware and/or software components configured to perform the specified functions. For example, the present embodiments may employ various integrated circuit components, e.g., memory elements, processing elements, logic elements, look-up tables, and the like, which may carry out a variety of functions under the control of one or more microprocessors or other control devices. Similarly, where the elements of the present embodiments are implemented using software programming or software elements the various embodiments may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present embodiments could employ any number of techniques of the related art for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the various embodiments and are not intended to otherwise limit the scope of the present disclosure in any way. For the sake of brevity, electronics, control systems, software development and other functional aspects of the systems according to the related art (and components of the individual operating components of the systems) may not be described in detail. Furthermore, the connecting lines, or connectors shown in the various figures presented are intended to represent functional relationships and/or physical or logical couplings between the various elements.

The use of the terms “a” and “an” and ‘the” and similar referents in the context of describing the disclosure (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or language (e.g., “such as”) provided herein, is intended merely to better illuminate the disclosure and does not pose a limitation on the scope of the disclosure unless otherwise claimed. Numerous modifications and adaptations will be readily apparent to those of ordinary skill in this art without departing from the spirit and scope of the present disclosure.

It should be understood that various embodiments described herein should be considered in a descriptive sense only and not for purposes of limitation. Descriptions of features or aspects within each embodiment should typically be considered as available for other similar features or aspects in other embodiments.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An operating method of a server for providing a cloud service, the operating method comprising:
receiving shared file information from each of a plurality of devices connected to the server;
transmitting the shared file information in response to a request from one of the plurality of devices; and
when receiving a request for a shared file included in the shared file information, receiving the shared file from a device in which the shared file is stored and transmitting the shared file to a device that requested the shared file.

2. The operating method of claim 1, further comprising:
when receiving a request for printing the shared file included in the shared file information, receiving the shared file from the device in which the shared file is stored, rendering the received shared file, and transmitting the rendered shared file to a device that requested the printing of the shared file.

3. The operating method of claim 1,
wherein the receiving of the shared file from the device in which the shared file is stored comprises receiving the shared file from the device in which the shared file is stored according to a streaming method, and
wherein the transmitting of the shared file to the device that requested the shared file comprises forwarding the shared file to the device that requested the shared file according to the streaming method.

4. The operating method of claim 1, wherein the transmitting of the shared file information in response to the request from the one of the plurality of devices comprises transmitting the shared file information with respect to other devices from among the plurality of devices except for the device that requested the shared file information.

5. The operating method of claim 1, wherein the shared file information comprises a list of files shared by each of the plurality of devices.

6. The operating method of claim 1, further comprising:
performing user authentication,
wherein the transmitting of the shared file information in response to the request from the one of the plurality of devices comprises transmitting the shared file information of an authenticated user.

7. A server for providing a cloud service, the server comprising:
a communicator configured to communicate with each of a plurality of devices connected to the server;
a memory configured to store a program for providing the cloud service; and
a processor configured to execute the program so as to:
receive shared file information from each of the plurality of devices connected to the server,
transmit the shared file information in response to a request from one of the plurality of devices, and
when receiving a request for a shared file included in the shared file information, receive the shared file from a device in which the shared file is stored and transmit the shared file to a device that requested the shared file.

8. The server of claim 7, wherein the processor is further configured to:
receive the shared file from the device in which the shared file is stored when receiving a request for printing the shared file included in the shared file information,
render the shared file, and
transmit the rendered shared file to a device that requested the printing of the shared file.

9. The server of claim 7, wherein the processor is further configured to:
receive the shared file from the device in which the shared file is stored according to a streaming method, and
forward the shared file to the device that requested the shared file according to the streaming method.

10. The server of claim 7, wherein the processor is further configured to transmit the shared file information with respect to other devices from among the plurality of devices except for the device that requested the shared file information.

11. The server of claim 7, wherein the shared file information comprises a list of files shared each of by the plurality of devices.

12. The server of claim 7, wherein the processor is further configured to:
perform user authentication, and
transmit the shared file information of an authenticated user.

13. A non-transitory computer-readable recording medium having embodied thereon a program for executing the operating method of claim 1.

14. An operating method of a user device in a cloud network, the method comprising:
transmitting, to a server, first shared file information;
receiving, from the server, second shared file information;
transmitting, to the server, a request for a shared file included in the second shared file information; and
receiving, from the server, the requested shared file,
wherein the second shared file information comprises all shared file information maintained at the server except for the first shared file information.

15. The method of claim 14, wherein the first shared file information comprises at least one of a user identifier, device information, and file information.

16. The method of claim 14, further comprising:
requesting the server to register user identification information;
transmitting, to the server, a user authentication request based on the registered user identification information; and
receiving, from the server, an authentication for the receiving of the second shared file information.

17. The method of claim 14, further comprising:
transmitting, to the server, a request for printing a shared file included in the second shared file information; and
receiving, from the server, a rendered shared file.

18. The method of claim 14, wherein the receiving, from the server, of the requested shared file comprises receiving the requested shared file according to a streaming method.

19. The method of claim 14, further comprising transmitting, to the server, a file included in the first shared file information.
